(19) United States
(12) Patent Application Publication
(10) Pub. No.: US 2006/0271550 A1
(43) Pub. Date: Nov. 30, 2006

(54) Method and system for remote document editing using a wireless communication device

(75) Inventor: Lovleen Chadha, San Diego, CA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Communications, Inc.

(21) Appl. No.: 11/139,204

(22) Filed: May 26, 2005

(51) Int. Cl. G06F 17/30; G06F 7/00

(52) U.S. Cl. 707/10

(57) ABSTRACT

A method and system for a wireless communication device. The method includes querying an external device for a file, receiving metadata regarding the file from the external device by the wireless communication device, and generating a preview image of the file based on the metadata and a capability of the wireless communication device. In some embodiments, the preview image is displayed on a display of the wireless communication device.

### BACKGROUND

The present disclosure relates generally to communication devices, and more particularly to a method and apparatus for receiving, viewing, and editing a file using the wireless communication device.

Modern wireless communication devices may include a number of components and/or functionalities. A sampling, not an exhaustive listing, of the type of components that may be included in a wireless communication device includes, for example, a memory (internal and/or removable device), a controller, a speaker, a microphone, and a graphics display. The wireless communication device may operate to provide various services and features using the components thereof.

The capability of the processors, memory, and displays of a number of wireless communication devices are becoming increasingly more powerful and capable of processing, storing, and displaying textual and graphical content files. However, transmitting and receiving text and graphic files by a wireless communication device may require sizable resources, including memory and transmission bandwidth.

Thus, there exists a need to provide an efficient device, system, method, and means for receiving, viewing, and editing a file using a wireless communication device.

### SUMMARY

In some embodiments hereof, an apparatus is provided. Some of the apparatuses may include a wireless communication device such as, for example, a mobile telephone or other device capable of communicating over, at least, a wireless communication link. The apparatus may include a processor, a radio frequency (RF) transmitter/receiver operatively coupled to the processor for receiving and transmitting information, and a memory operatively coupled to the processor and storing code to control the processor. The stored code may include executable instructions that, when executed, control the processor to query an external device for a file, receive metadata regarding the file from the external device, and generate a preview image of the file based on the metadata and a capability of the wireless communication device.

In some embodiments hereof, a method is provided. Some embodiments of the method may include querying an external device for a file, receiving, by the wireless communication device, metadata regarding the file from the external device, and generating a preview image of the file based on the metadata and a capability of the wireless communication device. In some embodiments, a method may include displaying the preview image on a display of the wireless communication device. In some embodiments still, a method may include retrieving additional data associated with the file from the external device during the displaying of the preview image on the display of the wireless communication device.

These and further aspects hereof may be more clearly understood by reference to the following detailed description, the appended claims, and to the several drawings attached herein.

### BRIEF DESCRIPTION OF THE DRAWINGS

Some embodiments are illustrated in the accompanying figures, in which like reference numerals designate like parts, and wherein:

FIG. 1 is an exemplary depiction of a wireless communication device, according to some embodiments herein;

FIG. 2 is an exemplary illustration of a system in accordance with some embodiments herein;

FIG. 3 is an exemplary block diagram of some components of FIG. 2, according to some embodiments;

FIG. 4 is an exemplary flow diagram of a method, according to some embodiments herein;

FIG. 5 is an exemplary depiction of a block diagram, according to some embodiments herein;

FIG. 6 is an exemplary flow diagram of a method, according to some embodiments;

FIG. 7 is an exemplary an exemplary flow diagram of a method, according to some embodiments;

FIG. 8 is an exemplary depiction of a rendering of a file, according to some embodiments herein; and

FIGS. 9-11 are exemplary depictions of a rendering of a document preview image of the file of FIG. 8, according to some embodiments herein.

### DETAILED DESCRIPTION

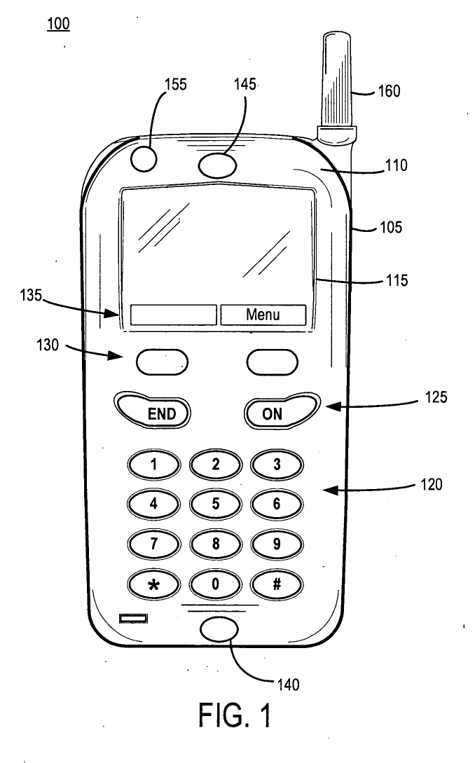

Referring to FIG. 1, there is shown an exemplary illustration of an embodiment of an apparatus, a wireless communication device, according to some embodiments hereof. The wireless communication device is generally represented by numeral 100. Wireless communication device 100 may include various components, functionalities, and technologies to provide a variety of features and capabilities, including multimedia capabilities. Wireless communication device 100 may include, as an example, a cellular telephone, a wireless telephone, a personal digital assistant (PDA), a push-to-talk (PTT) walkie talkie, a desktop personal computer (PC), a handheld PC, a combination of these and other devices, and any other device that may include the same, like or other functionality in accordance with the present disclosure.

Wireless communication device 100 may be programmed to perform certain functions (e.g., to operate in various modes and execute various actions) in accordance with aspects of the present disclosure. The program instructions or code may be stored in a memory device associated with wireless communication device 100. In some embodiments, the memory may be resident to wireless communication device 100. The memory, in some embodiments, may be removably connected to wireless communication device 100. For example, a memory including programming that when executed implements some of the methods and functions disclosed herein may be stored on a memory device such as, but not limited to, those commonly referred to as compact flash, secure digital, memory stick, smart media; multimedia, and microdrive. A removable memory device may be received in a socket (not shown) configured to accept the memory device. The socket may be located in wireless communication device 100 and at least operatively connected thereto.

Wireless communication device 100 includes a housing 105, including a front housing 110 that may be shaped and sized to fit in a user's hand. Other components of wireless communication device 100, described in greater detail below, are mounted on, to, or within housing 105.

Wireless communication device 100 includes a display 115 that is mounted to front housing 110. Wireless communication device 100 also includes a numeric keypad 120. Keypad 120 may be mounted on, in, or through front housing 110 such that keypad 120 is accessible to the user. Wireless communication device 100 may include a number of certain, fixed function keys 125. Fixed function keys 125 may be associated with a predetermined function and/or feature of wireless communication device 100. For example, fixed function keys 125 may operate to initiate and terminate certain features and functions such as power. Functions keys 125 may be labeled, as shown, as ON and END.

Wireless communication device 100 may have a number of keys commonly referred to as “soft” function keys 130. Softkeys 130 are accessible from front housing 110. A function associated with softkeys 130 may vary in accordance with a function label 135 displayed on display 115.

Front housing 110 may include a microphone 140 for receiving an audio signal and a speaker 145 for broadcasting an audio signal. Wireless communication device 100 may include a camera (not shown) for receiving a visual signal. In some embodiments, the camera may include functionality for receiving infrared (IR) signals.

Housing 105 may include these and/or other keys, components, and the like on front housing 115 thereof and other portions of housing 105, including a back, a top, and sides of housing 105 that are not shown, so as to simplify the exemplary illustration of FIG. 1. Further, wireless communication device 100 may include keys, a battery, components, and the like (not shown for purposes related to clarity of the drawing) that are concealed from view by, for example, portions of housing 105 that are fixed or selectively moveable to conceal these other keys, components, and the like.

An antenna 160 extends from the top of housing 105. Antenna 160 is operatively coupled to a receiver/transmitter and aids in the transmission and reception of radio frequency (RF) signals transmitted and received by the receiver/transmitter. Antenna 160 may or may not be extendable to a length other than that illustrated in FIG. 1. Antenna 160 may, in some embodiments, be housed entirely within housing 105.

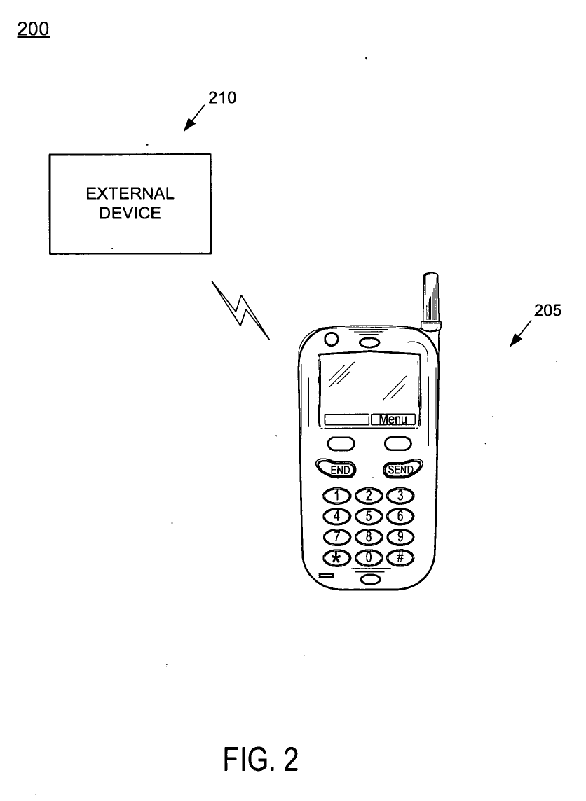

FIG. 2 is an exemplary diagram of system 200 according to some embodiments herein. System 200 includes a wireless communication device 205 and an external device 210. According to some embodiments, wireless communication device 205 queries external device 210 for a file and receives metadata related to the file from external device 210. In some embodiments, external device 210 is capable of wirelessly communicating with wireless communication device 205 to facilitate a transfer of information associated with the requested file to wireless communication device 205. In some embodiments herein, external device 210 responds to the query for the file by wirelessly transmitting metadata associated with the requested file to wireless communication device 205. External device 210 may include, for example, a host PC, a server, or other device or system having functionality compatible with the present disclosure.

In some embodiments, metadata refers to data associated with a file that describes attributes and other information about the file. The metadata may refer to special tagged fields in a document that provide information about the document to search engines and other computer applications, such as layout information and placeholders for objects (e.g., text, graphics, formatting structures, etc.). Metadata may include information regarding the source, author, time of creation, time last saved, and other information related to and/or descriptive of the file and the data content thereof. In some embodiments, metadata may include a subset of the actual data content of an associated file. The subset of data may be a relatively small portion of the data content of the file, for example, a first few words of paragraph, a first and/or last line of a paragraph and/or page, or other limited data of the file.

In some embodiments, the metadata associated with a file requires fewer resources to store and transmit than the full content of data of the file. That is, for example, metadata associated with and descriptive of a document file including text and graphics may be, in general, smaller than the document file. Accordingly, fewer resources may be used to store, transmit, and otherwise process metadata associated with a file relative to the storing, transmitting, and other processing of the file itself. The metadata associated with a file may be smaller than the associated file since, for example, the metadata is a description of the file, not the entirety of the data content of the file.

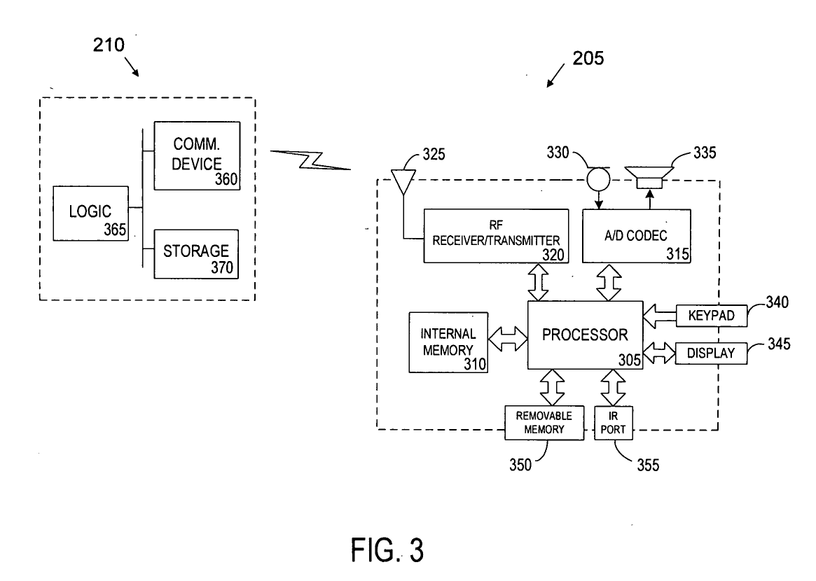

FIG. 3 is an exemplary block diagram of some potential components for the system of FIG. 2, in accordance with some embodiments of the present disclosure. As illustrated, wireless communication device 205 includes a processor 305. Processor 305 may be a microprocessor, microcontroller and/or digital signal processor (DSP) or other control circuit provided in a wireless communication device. Also included in wireless communication device 205 is a memory component 310. Memory 310 may include one or more of ROM (read only memory), RAM (random access memory, e.g., static RAM, dynamic, etc.), and flash memory. Processor 205 is operatively connected to (i.e., in data communication with) memory 310. Memory 310 may store software code, instructions, including programs that control operation of the processor 305.

In some embodiments, wireless communication device 210 includes a removable memory 350 connected thereto. Removable memory 350 be any type of currently known (e.g., compact flash, smartmedia, microdrive, etc., and any future developed removable storage mechanism device, system.

Some of the software of wireless communication device 205 may be provided in accordance with the present disclosure to cause processor 305 to perform functions further described below.

A codec (coder/decoder) 315 may be included in wireless communication device 205. Codec 315 is, operatively connected, in data communication with the processor 305. A receiver/transmitter 320 is operatively coupled to codec 315. Receiver/transmitter 320 is operatively coupled to antenna 325. Receiver/transmitter 320 may comprise a combination of two or more different receive/transmit modules (not separately shown) that operate in accordance with mutually different radio communication protocols to provide various services for wireless communication device 205. For example, receiver/transmitter 320 may operate in accordance with one radio communication protocol to provide conventional cellular two-way service for wireless communication device 205, and may operate in accordance with another radio communication protocol to provide PTT service for wireless communication device 205. Wireless communication device 205 may operate in accordance with a number of communication standards, such as, for example, GPRS (General Packet Radio Service), EDGE (Enhanced Data GSM Environment), UMTS (Universal Mobile Telephone Service).

Wireless communication device 205 may also include an IR (infrared) port 355 for transmitting and receiving infrared signals. In some embodiments, the IR signals may function as a carrier for information, such as information associated with transferring a file from/to external device 210.

Microphone 330 is operatively coupled to codec 315 to provide audio (e.g., voice) input signals to codec 315. A speaker 335 is operatively coupled to codec 315. Speaker 335 may be driven by codec 315 to provide audible output therefrom.

Keypad 340 and display 345 are operatively coupled to processor 305. Display 345 is operatively coupled to processor 305 to provide a display area for graphical output. The graphical output may include text and graphics. The graphics may include image data such as still photograph images and motion video. The graphical output may be stored in memory 310 or removable memory 350 or received by receiver/transmitter 320 and IR port 355. Display 345 may form, in part, a graphical user interface of wireless communication device 205. In some embodiments hereof, display 345 may include a touch-sensitive screen to receive input from a user of wireless communication device 205.

Regarding external device 210, there is shown simplified block diagram of an exemplary external device having a communication device 360, processing logic 365, and associated storage device 370. Communication device 360 provides functionality for external device 210 to communicate with wireless communication device 205. Processing logic 365 may be used to handle processing requests, commands, and other logic functions requested or provided to external device 210. Storage device 370 may be used to off-load certain memory storage functions from wireless communication device 205. In some embodiments herein, the processing and storage capabilities of external device 210 may be used to process and store information in lieu of, in cooperation with, and in assistance to the processing and memory management functions of wireless communication device 205. Communication device 360 is used in some embodiments herein to facilitate the operational communication and relationship between external device 210 and wireless communication device 205.

While external device 210 is depicted as a single device in FIGS. 2 and 3, external device 210 may comprise one or more devices or systems having at least the functionality disclosed herein. For example, and not as a limitation, external device 210 may include a mobile telephone, a desktop computer, a laptop computer, a handheld computer, a PDA, a digital media player, a digital camera, a wireless email device, and any other device, devices, or system from which a file, stored or at least accessible, may be transmitted.

It should be understood that the block diagram representations of wireless communication device 205 and external device 210 shown in FIGS. 2 and 3 are examples of some embodiments herein and are simplified in a number of ways. For example, certain power, and power management components of the wireless communication device and the external device are omitted from the drawings.

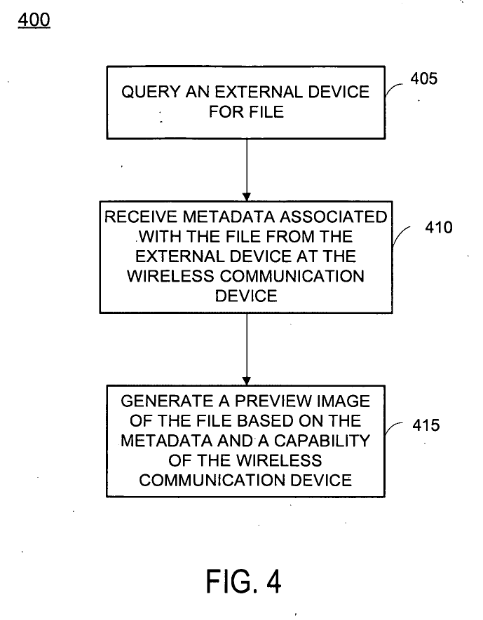

FIG. 4 is an exemplary flow diagram that illustrates a process 400 that may be performed by a wireless communication device in accordance with some aspects of the present disclosure. Process 400 relates to controlling an operation of a wireless communication device. In particular, process 400 depicts an exemplary process for controlling a wireless communication device to receive and process a file, including generating a preview image of the file. Process 400 may be embodied in program code and/or executed by wireless communication device 205 or another device using any suitable hardware and/or software arrangement. For example, memory 310 and removable memory 350 may be used to store portions of program code and processor 305 may be used to execute portions of the program code to effectuate process 400.

The methods of operation disclosed herein are, in general, not limited by any title or descriptor associated therewith, but in general are associated with the operations, steps, process, functions, etc. used, disclosed, and suggested in the description of the methods. It should be appreciated that the order of the depicted operations of the flow diagrams are not intended to limit the methods herein to a particular order or sequence of operations.

Transmission(s) of files and information associated with a file, such as metadata and/or at least a portion of the file may be performed using any wired or wireless transmission system that is or becomes known, including various combinations of wired and wireless communication links having a variety of protocols, frequencies, power, etc.

At an initial operation 405, an external device is queried for a file. The query may be presented in any format suitable to the external device. The query may be transmitted via any transmission media and protocols compatible with the external device. In some embodiments, the query to the external device (e.g., 210) may be transmitted in response to a user input received by the wireless communication device (e.g., 205). The user input may include, for example, a request for the file. In some embodiments the query may be transmitted in response to a process to transfer a file to wireless communication device 205 by another device, system, or service. That is, in some embodiments instead of directly receiving a transmission or transfer of a file, wireless communication device may invoke a process such as process 400 to control a receipt of the file by wireless communication device 205.

The query of the external device for the requested file may be communicated to the external device via a wireless communication link between the wireless communication device 205 and the external device 210. The communication link may include any of a number of known and future developed communication systems and protocols.

At operation 410, wireless communication device 205 receives metadata associated with the file from external device 210. In some embodiments, the file queried for is stored in memory associated with the external device. For example, the file may be stored in a memory device connected (fixed, internal, or removable) to external device 210. As mentioned above, the metadata is descriptive of various aspects of the file, and does not contain the entirety of the content of the file. Accordingly, the metadata associated with the file, in general, is smaller than the entire content of the file. Thus, the resources (e.g., memory, transmission bandwidth, and processing power) needed to store, transmit, and process the metadata may be reduced relative to the memory, transmission bandwidth, and processing power needed to store, transmit, and process the file data itself.

At operation 415, wireless communication device 205 generates a preview image of the file based on the metadata and a capability of the wireless communication device. In some embodiments, a preview image includes a lower resolution rendering of the file, a graphic representation of data associated with the file, a limited portion of data associated with the file, and combinations thereof. The graphic representations may include place-holders, icons, shaded areas, hyperlinks, or other objects representative of the content (e.g., text and graphics) of the file.

Wireless communication device 205 may receive the metadata from a external device 210 according to any protocol and via any medium (wireless and wire) compatible with wireless communication device.

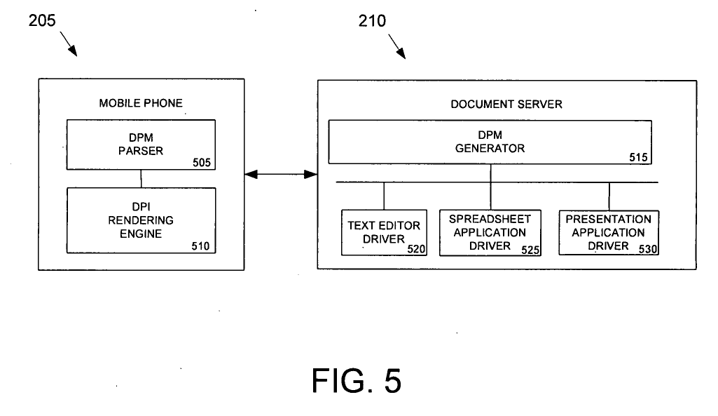

FIG. 5 is an exemplary functional block diagram illustrating a number of aspects of wireless communication device 205 and external device 210. Wireless communication device 205, for example a mobile phone, includes a document preview metadata (DPM) parser 505 and a document preview image (DPI) rendering engine 510. DPM parser 505 processes (i.e., parses) metadata received from an external device 210, for example a document server. The processing provided by DPM parser 505 may include analyzing DPM data and routing relevant DPM data to DPI rendering engine 510. DPI rendering engine 510 operates to display a preview image on a display of mobile phone 205. The metadata provided by file server 510 may be in response to a query for a file from the file server as discussed with regard to FIG. 4.

Document server 210 includes a number of drivers, supporting the types of documents processed thereby, to parse different types of corresponding documents. For example, document server 210 includes a text editor driver 520 to parse text files, a spreadsheet application driver 525 to parse a file containing spreadsheets, and a presentation application driver 530 to parse files containing presentations. The appropriate driver(s) parse a file and forwards the data to a DPM generator 515. DPM generator 515 generates metadata associated with a file that is transmitted to mobile phone 205 in response to a query for the file. It should be appreciated that any number of application drivers and the like may be included in document server 210 to accommodate a variety of different file types.

In some embodiments herein, wireless communication device 205 is capable of handling (i.e., receiving and processing) metadata associated with a variety of different file types in an instance the metadata associated with the files is formatted to be compatible with wireless communication device 205. The wireless communication device may thus operate independent of a particular format of a file. Any file dependent processing may be handled by the external device 210 (e.g., document server), including the application drivers therein.

It should be appreciated that external device 210 may handle certain functions and/or processing of a file. Such functions include printing a documents and transmitting a message (e.g., SMS, MMS, etc.) including or reporting a status of the file. Further, processing by the external device may not involve over-the-air transmission or using transmission bandwidth to provide the processing functionality.

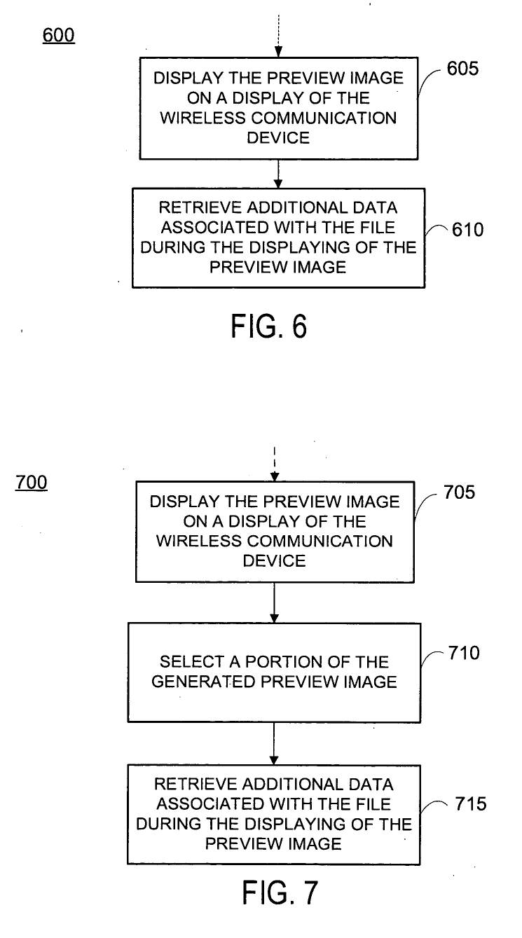

FIG. 6 is a flow diagram of a process 600 according to some embodiments. Process 600 may be embodied in hardware and/or software of wireless communication device 205, external device 210, and/or one or more other suitable devices. Process 600 may, in some embodiments, be a continuation of process 400 or another process. At operation 605, wireless communication device displays the preview image generated at, for example, operation 415 of process 400.

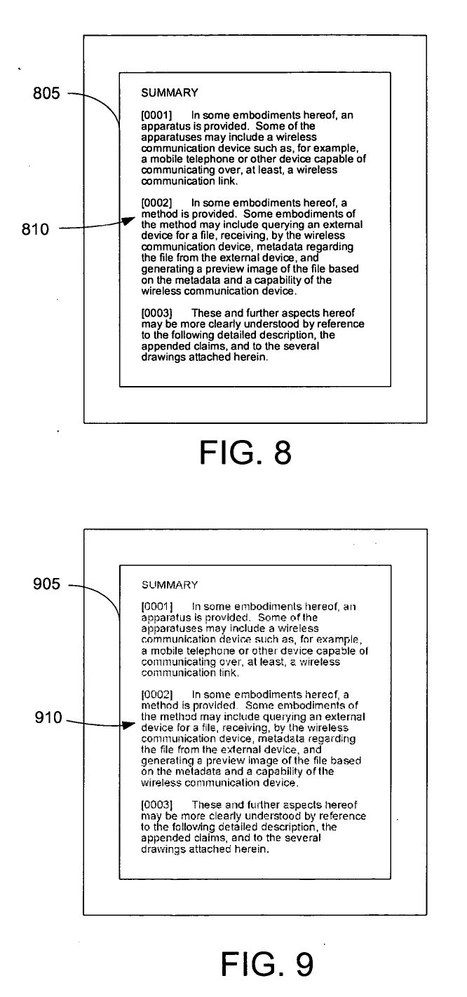

In some embodiments, the display of the preview image will generally contain less information associated with the file than a display of the information associated with the file. For example, FIG. 8 is an exemplary depiction of a display 805 of a file image 810 (e.g., a text document). File image 810 is rendered at full resolution (i.e., a native resolution) specified for the file. In some embodiments, file image 810 of FIG. 8 is rendered at a highest resolution level of the wireless communication device displaying the file image.

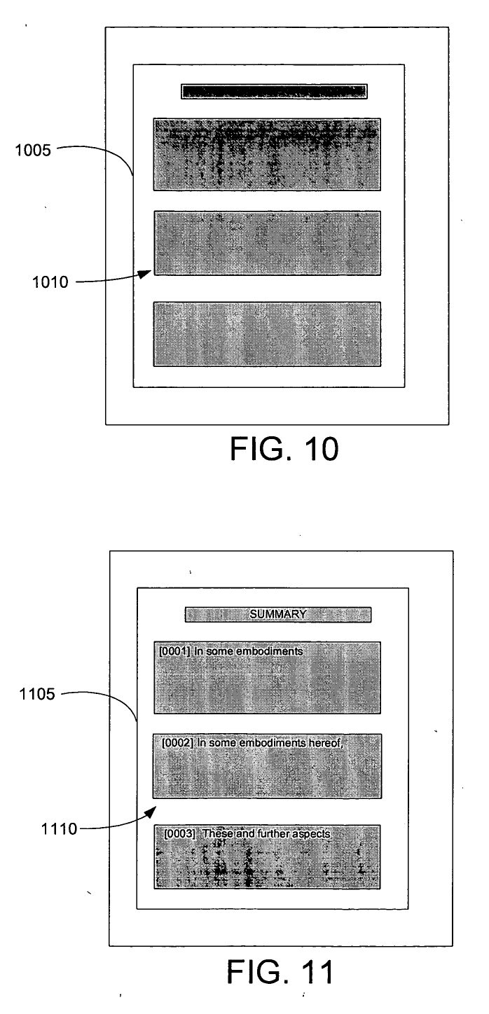

FIGS. 9-11 are exemplary depictions diagrams of a display of a preview image of the file. FIG. 9 illustrates a display 905 of a preview image 910. Preview image 910 is a lower resolution rendering of the file (e.g., a text document) queried for by the wireless communication device. The reduced resolution of preview image 910 relative to image 810 is seen from a viewing of FIGS. 8 and 9. FIG. 10 illustrates a display 1005 of a preview image 1010. Preview image 1010 includes a graphic representation of the data content of the file. The graphic representation of the data content of the file may include a shaded area of a display, a colored area of a display (e.g., different colors having different meanings), and icons or other graphics. For example, FIG. 10 includes a shaded area to represent the various paragraphs of the queried for file. Each shaded block of area in FIG. 10 corresponds to a paragraph of text and/or graphics. FIG. 11 illustrates a display 1105 of a preview image 1110. Preview image 1010 includes a graphic representation of the content of the file and a limited portion of the content (e.g., text) of the file. As shown, FIG. 11 includes a shaded area to represent the various paragraphs of the queried for file with each shaded area having, for example, about 2 to about 8 introductory words of paragraph represented by the shade areas.

Returning to FIG. 6, in some embodiments of process 600 include an operation 610. At operation 610, additional data associated with the queried for file is received from the external device. The additional information associated with the file may include at least a portion of the content of the file. In some embodiments, retrieval of the additional data may occur during a display of a preview image that is based on the metadata and a capability of the wireless communication device. In some embodiments, the retrieval of the additional information is invoked by a user or initiated automatically.

In some embodiments, the displaying of a preview image prior to the retrieval of the entirety of the content of data, or at least that portion of data content used to provide a full resolution rendering of the file, may facilitate efficient viewing of a file that is transmitted from an external device and displayed by a wireless communication device.

FIG. 7 is a flow diagram of a process 600 according to some embodiments. Process 700 may be embodied in hardware and/or software of wireless communication device 205, external device 210, and/or one or more other suitable devices. Process 700 may, in some embodiments, be a continuation of process 400 or another process. At operation 705, wireless communication device displays the preview image generated at, for example, operation 415 of process 400.

At operation 710, a portion of the preview image is selected or otherwise indicated for viewing and/or editing. In response to a user input or actions of selecting at least a portion of the preview image, at least a portion of additional data content associated with the file is retrieved. In some embodiments, the data content associated with the selected or otherwise indicated portion of the preview image is retrieved.

At operation 715, additional data associated with the queried for file is received from the external device. The additional information associated with the file may include at least a portion of the content of the file. In some embodiments, retrieval of the additional data may occur during a display of a preview image that is based on the metadata and a capability of the wireless communication device.

While various embodiments of the present disclosure have been discussed in the context of a wireless communication system, the wireless communication devices and external devices discussed herein may communicate via a wired or wireless communication link. Benefits, such as the off-loading of various processing functions to the external device, may be realized in a system wherein the communication link is wired, at least partially.

Embodiments described above are not intended to be limited to the specific form set forth herein, but are intended to cover such alternatives, modifications and equivalents as can reasonably be included within the spirit and scope of the appended claims.

What is claimed is:

1. A method for a wireless communication device, comprising:
querying an external device for a file;
receiving, by the wireless communication device, metadata regarding the file from the external device; and
generating a preview image of the file based on the metadata and a capability of the wireless communication device.

2. The method of claim 1, further comprising displaying the preview image on a display of the wireless communication device.

3. The method of claim 2, further comprising retrieving additional data associated with the file from the external device during the displaying of the preview image on the display of the wireless communication device.

4. The method of claim 3, wherein the retrieving of the additional data associated with the file is automatically invoked during the displaying of the preview image on the display of the wireless communication device.

5. The method of claim 1, wherein the preview image comprises a reduced resolution rendering of data associated with the file, a graphic representation of data associated with the file, a limited portion of data associated with the file, and combinations thereof.

6. The method of claim 5, wherein the graphic representation of data associated with the file includes at least one of a colored area and an icon.

7. The method of claim 1, wherein the metadata is received using a wireless communication link.

8. The method of claim 1, further comprising:
selecting a portion of the generated document preview image; and
initiating, in response to the selecting, a retrieval of additional data associated with the file from the external device.

9. The method of claim 8, further comprising displaying the retrieved additional data.

10. The method of claim 8, further comprising invoking an editing function of the wireless communication device.

11. A wireless communication device comprising:
a processor;
a radio frequency (RF) transmitter/receiver, operatively coupled to the processor, for receiving and transmitting information; and
a memory operatively coupled to the processor and storing code to control the processor to:
query an external device for a file;
receive, by the wireless communication device, metadata regarding the file from the external device; and
generate a preview image of the file based on the metadata and a capability of the wireless communication device.

12. The wireless communication device of claim 11, further comprising a display for displaying the preview image thereon.

13. The wireless communication device of claim 12, further comprising retrieving additional data associated with the file from the external device during the displaying of the preview image on the display of the wireless communication device. retrieving of the additional data associated with the file is automatically invoked during the displaying of the preview image on the display of the wireless communication device.

15. The wireless communication device of claim 11, wherein the preview image comprises a reduced resolution rendering of data associated with the file, a graphic representation of data associated with the file, a limited portion of data associated with the file, and combinations thereof.

16. The wireless communication device of claim 15, wherein the graphic representation of data associated with the file includes at least one of a colored area and an icon.

17. The wireless communication device of claim 11, wherein the metadata is received using a wireless communication link.

18. The wireless communication of claim 11, further comprising stored code to control the processor to initiate, in response to a selection of a portion of the generated document preview image, a retrieval of additional data associated with the file from the external device.

19. The wireless communication device of claim 18, further comprising stored code to control the processor to display the retrieved additional data.

20. The wireless communication device of claim 18, further comprising stored code to control the processor to invoke an editing function of the wireless communication device.
